(19) United States
(12) Patent Application Publication
(10) Pub. No.: US 2025/0385852 A1
(43) Pub. Date: Dec. 18, 2025

(54) TRAFFIC MANAGER FOR BUFFER BASED ON TARGET UTILIZATION-LATENCY

(71) Applicant: Ceragon Networks Ltd., Rosh HaAyin (IL)

(72) Inventors: Tzalik MAIMON, Tel Aviv (IL); Gil KEDAR, Zur Moshe (IL)

(73) Assignee: Ceragon Networks Ltd., Rosh HaAyin (IL)

(21) Appl. No.: 19/237,086

(22) Filed: Jun. 13, 2025

Related U.S. Application Data
(60) Provisional application No. 63/659,413, filed on Jun. 13, 2024.

(51) Int. Cl. H04L 43/0864; H04L 43/067; H04L 43/16; H04L 47/125; H04L 47/32

(52) U.S. Cl. CPC H04L 43/0864; H04L 43/067; H04L 43/16; H04L 47/125; H04L 47/32

(57) ABSTRACT

A method of management of packet data traffic at a node on a network, the node having one or more input channels, a buffer, a latency depending on buffer usage, one or more output channels and an overall channel capacity, involves using channel utilization and packet latency together to decide whether to drop packets. Specifically, a current incoming data rate is compared with the overall channel capacity to obtain a current utilization, and a current latency is obtained from comparing the incoming data rate with overall output channel capacity. Then a ratio is obtained by comparing the current utilization with a desired utilization, and the current latency with a desired latency. If the ratio is above a threshold then incoming packets are dropped.

### RELATED APPLICATION(S)

This application claims the benefit of priority under 35 USC § 119(e) of U.S. Provisional Patent Application No. 63/659,413 filed on Jun. 13, 2024, the contents of which are incorporated herein by reference in their entirety.

### FIELD AND BACKGROUND OF THE INVENTION

The present invention, in some embodiments thereof, relates to a traffic manager device and method for a buffer wherein the traffic management is based on target utilization latency and, more particularly, but not exclusively, to such a device and method as used with the transmission control protocol (TCP) for data packets.

As part of the TCP protocol, packet drops are used to prevent a TCP flow from overloading the traffic channels in the network. Any point along the route of a packet, whether that point is a router or a target, can drop a packet causing a change in the rate in which the flow sends packets in the network. As packets drop, the rate decreases and the question as to when and how to drop packets in routers rises.

Routers usually contain a buffer within which packets are temporarily retained if the outgoing channel is at maximum capacity-maxed. Packets in the buffer wait for the channel to be available again before the router forwards them. The waiting time in the buffer, however, adds to the latency of each packet. Therefore, the bigger the buffer, the bigger the addition to the latency of a packet. If we have a small buffer, packets reaching a router with a maxed outgoing channel are dropped and the TCP protocol slows down. Either case has its disadvantages but both are preferable to packets blocking the channel without reaching their target.

Another issue that we have with dropping packets in the router is the concept of fairness. If we just drop packets without concern, we might decrease a single TCP flow out of many entering the router. Not only this is not a fair strategy, we can also gain nothing from a drop of a packet as we might drop a packet from a flow that is already of slow rate while other flows are the ones overloading the channels and we might end up with insufficient buffer size, resulting in more packet drops than intended.

Thus, we are faced with a compound problem, that is to say we wish for low latency for packets which are sent. However slowing down the TCP flow causes low utilization of channels in the network. Thus we have to choose a best size of buffer in the router, and we have to decide when and how to drop packets in the router.

The problem described above is known as Bufferbloat, as the natural and obvious solution for TCP traffic management in routers has simply been to use larger buffers. However, large buffers cause latency to rise and thus latency starts to become an issue in networks.

To the best of our knowledge, there are four techniques for managing traffic in routers today. The most primitive and default one is call Tail-Drop. This is where the router fills the buffer to the full and any packets incoming while the buffer can hold no more are dropped. This has proven to cause poor utilization in channels and large latency times for packets in cases of large buffer sizes.

To improve on simple tail-drop, Active Queue Management (AQM) techniques started to be developed. A classic one is a method called Random Early Detection (RED). RED relies on the current average queue size in the buffer over a given time interval, and decides if packets should be dropped before the buffer is full. Although being preferable to Tail-Drop, the issue of configuring the parameters of RED is prevalent and many prefer to refrain from using it due to this problem. Later, this was address by developing the Self Configuring RED and Adaptive RED Queue Discipline. These algorithms provided only partial solutions as the automatic configuration did not provide required results for different cases and uses of communication networks.

More recently, a new approach has been introduced which considers the actual latency in the traffic management. Controlled Delay (CoDel) takes such an approach. But it requires an implementation yet to exist in many routers as it needs a measurement of data from dequeueing packets. Another deficiency of CoDel is that it drops packets only after dequeueing, meaning that some of the buffer is unnecessarily held up by packets that are dropped before leaving the router.

CoDel has only a small footprint in terms of memory and only has two configurable parameters in comparison to RED. However the two parameters still require tuning per use case.

Another algorithm that takes on the approach of evaluating the latency is Proportional Integral controller-Enhanced (PIE). Just like Codel, PIE decides on dropping packets as a function of the latency evaluated by the algorithm. The benefit of CoDel is that it is deterministic in its dropping strategy while PIE adjusts a probability parameter for dropping each incoming packet. From tests, it is clear that PIE achieves a target latency quicker than CoDel. This is not necessarily a benefit as it makes PIE more zealous, decreasing utilization while CoDel allows the network some time to stabilize by itself.

While CoDel and PIE are reasonable steps towards managing traffic as a function of latency, they lack explicit consideration of the other side of the coin-utilization. In an extreme case, we can drop many packets for retaining low latency but we will also drop the utilization of the channels in the network.

### SUMMARY OF THE INVENTION

In the present embodiments, channel utilization is used together with latency at a given node to decide whether the node is to drop packets or not.

The embodiments may encompass a method of management of packet data traffic on a network at a node having one or more input channels, a buffer, a latency depending on buffer usage, one or more output channels and an overall channel capacity.

The node obtains data of channel utilization and packet latency together to decide whether to drop packets. Specifically, a current incoming data rate is compared with the overall channel capacity to obtain a current utilization, and a current latency is obtained from comparing the incoming data rate and current buffer size with overall output channel capacity. Then a ratio is obtained by comparing the current utilization with a desired utilization, and the current latency with a desired latency. If the ratio is above a threshold then incoming packets are dropped.

The overall channel capacity, the output channel capacity, the desired latency and the desired utilization are all fixed values, and the one variable that changes and requires measurement is the incoming data rate.

The data packets that are dropped may be selected in turn from the different data flows or incoming channels, say using a round robin selection process.

According to an aspect of some embodiments of the present invention there is provided a method of management of packet data traffic at a node on a network, the node having at least one input channel, at least one buffer, a latency depending on buffer usage, at least one output channel and an overall channel capacity, the method comprising:
obtaining a current incoming data rate and comparing it with the overall channel capacity to obtain a current utilization;
obtaining a current latency by comparing the incoming data rate with an overall output channel capacity;
obtaining a ratio by comparing the current utilization with a desired utilization, and the current latency with a desired latency; and
if the ratio is above a threshold then dropping incoming packets.

In embodiments, the at least one incoming channel comprises a plurality of incoming channels, the method comprising evenly selecting packets for the dropping from different ones of the plurality of incoming channels.

In embodiments, the obtaining a current incoming data rate and obtaining the ratio is carried out for successive time intervals.

In embodiments, the threshold is unity.

In embodiments, the overall channel capacity is an overall input channel capacity and the current utilization is calculated from the input channel capacity.

In embodiments, the current latency further comprises an estimate of data packets waiting in the buffer, the estimate being obtained from differences between respective input data rates of the earlier time periods compared with the output channel capacity.

In embodiments, if the ratio is above the threshold, a single packet is dropped and then the ratio is re-evaluated, and following the re-evaluation:
if the ratio is found to have increased then the time interval is halved and a further packet is dropped;
if the ratio is found not to have increased but is still above the threshold then the time interval is set to the minimum of double a current time interval and half an original time interval and a further packet is dropped; and
if the ratio is no longer above the threshold no packet is dropped.

In embodiments, successive ones of the packets being dropped are dropped from different ones of the input channels.

In embodiments, if the ratio is above the threshold:
a number of packets to be dropped is obtained by comparing the ratio to the current incoming data rate;
one packet is dropped from a first of the plurality of input channels and the number of packets to be dropped is decremented;
further packets are dropped from successive ones of the plurality of input channels with corresponding decrementing of the number of packets to be dropped, until the number of packets to be dropped reaches zero.

In embodiments, the number of packets to be dropped is an estimate of how many packets need to be dropped from the current incoming data rate to reduce the ratio to unity.

The method may comprise dropping the incoming packets prior to entering the buffer.

In embodiments the method may involve modifying the ratio based on a trend obtained from successive measurements of the incoming data rate over successive time intervals.

According to a second aspect of the present invention there is provided a node for transfer of packet data over a network, the node having a packet management unit, at least one input channel, at least one buffer, a latency depending on buffer usage, at least one output channel and an overall channel capacity, the node comprising:
a measurement unit configured to obtain a current incoming data rate;
a comparator connected with the measurement unit and configured to compare the current incoming data rate with the overall channel capacity to obtain a current utilization;
a latency unit configured to obtain a current latency by comparing the incoming data rate with an overall output channel capacity;
a ratio unit connected to the latency unit and the comparator, for obtaining a ratio by comparing the current utilization with a desired utilization, and the current latency with a desired latency; and
a packet dropping unit connected to the ratio unit to drop incoming packets if the ratio is above a threshold.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic diagram which illustrates a network node for routing packet data around a network, to which the present embodiments are applied;

FIG. 2 is a simplified schematic diagram which shows a detail of FIG. 1, namely which concentrates on a single input, leading to a single buffer and then to an output;

FIG. 3 is a simplified diagram illustrating utilization and latency in the context of FIG. 2;

FIG. 4 is a schematic illustration of a calculation of the decision to drop packets according to embodiments of the present invention;

FIGS. 5, 6, 7, 8, 9, 10, 11 and 12 provide a simplified schematic illustration of a buffering and packet dropping process according to embodiments of the present invention;

FIG. 13 is a simplified flow chart illustrating a procedure for evaluating the value P, and the drop count;

FIG. 14 is a simplified flow chart illustrating a single drop method according to embodiments of the present invention;

FIG. 15 is a simplified flow chart which illustrates a target ratio drop method according to embodiments of the present invention; and

FIG. 16 is a simplified schematic diagram of a node according to embodiments of the present invention.

### DESCRIPTION OF SPECIFIC EMBODIMENTS OF THE INVENTION

The present embodiments may provide a traffic manager device and method for a buffer wherein the traffic management is based on target utilization.

A method of management of packet data traffic at a node on a network, the node having one or more input channels, a buffer, a latency depending on buffer usage, one or more output channels and an overall channel capacity, involves using channel utilization and packet latency together to decide whether to drop packets. Specifically, a current incoming data rate is compared with the overall channel capacity to obtain a current utilization, and a current latency is obtained from comparing the incoming data rate with overall output channel capacity. Then a ratio is obtained by comparing the current utilization with a desired utilization, and the current latency with a desired latency. If the ratio is above a threshold then incoming packets are dropped.

The present embodiment may provide a technique that address many of the hard-taught lessons of previous active queue management techniques (AQM) s.

The present embodiments may take into account both latency and utilization as a function for deciding whether to enter a packet dropping stage.

The present embodiments may use a fair strategy for dropping packets so that any single TCP flow may not be hit by too many drops.

The present embodiments may operate to drop incoming packets, unlike CoDel which drops outgoing packets and thus avoids CoDel's use of buffer space resources for packets that do not reach their destination.

Unlike CoDel, the present embodiments may offer a drop strategy which is executed at constant intervals regardless of how many packets need to be dropped and therefore is less performance heavy.

The present embodiments do not require to be specifically configured for different use cases and network environments, but rather only target latency and target utilization, which is demand related, not case related.

The present embodiments have very low memory requirements, certainly relative to other AQMs, and memory is a scarce resource in routers.

The present embodiments require few divisions and therefore are relatively speaking very efficient in each single iteration.

The present embodiments are deterministic and therefore can be predicted for any given data flow.

The present embodiments require hardware abilities already existing in most routers.

Unlike CoDel, which adds a timestamp to the packets and then reads them, the present embodiments do not require writing to or reading from the packets or their headers.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

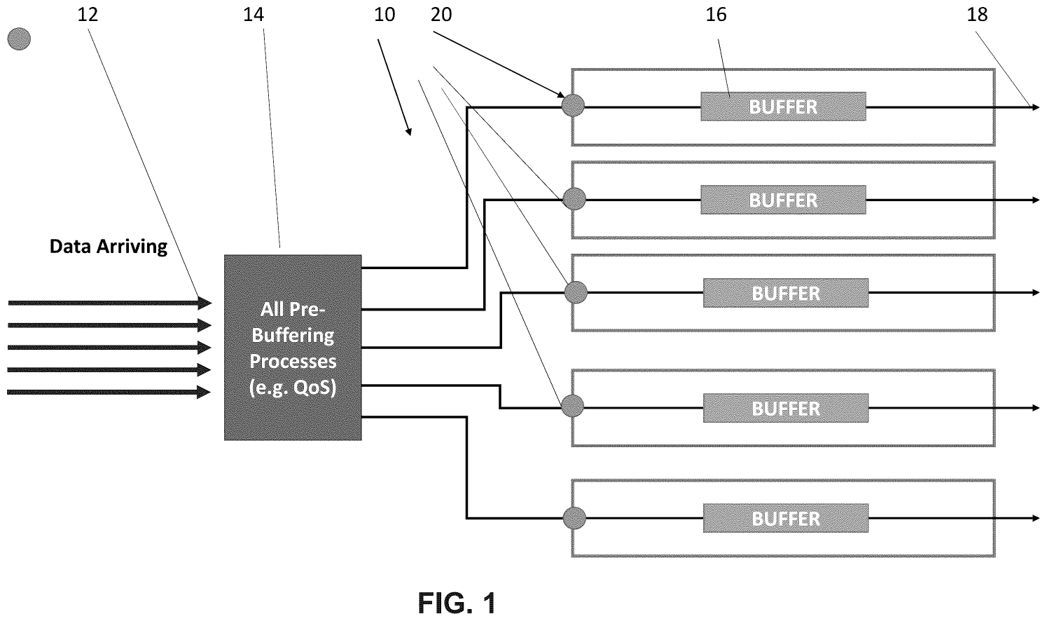

Referring now to the drawings, FIG. 1 illustrates a network node 10 for routing packet data around a network, to which the present embodiments are applied. The node 10 comprises inputs 12 for data to arrive. The data arriving may come from one or more previous nodes on the network and may include multiple data flows and channels. The arriving data is preprocessed as necessary, for example for different quality of service levels, at pre-buffering unit 14. The packets then reach multiple buffers 16 which each lead to a different output path 18, leading to other nodes on the network. Data management units 20 are located after the pre-buffering processes 14 and prior to the buffers to remove packets it is decided to drop before they enter the buffers and take up space.

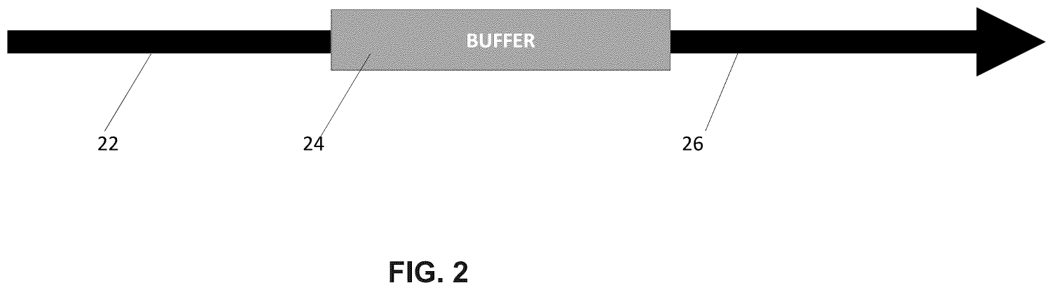

Reference is now made to FIG. 2, which concentrates on a single input 22, leading to a single buffer 24 and then to an output 26.

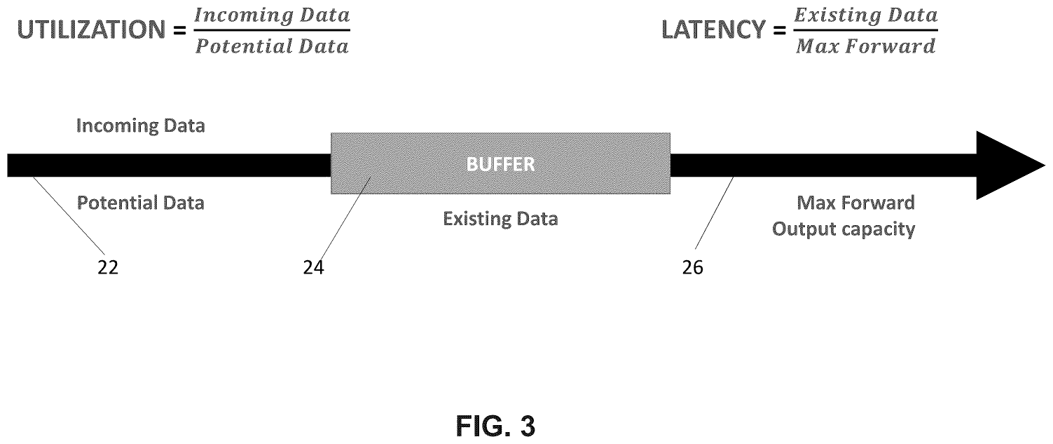

With reference to FIG. 3, in any given time interval, data arriving via input 22 is measured—incoming data. The capacity of the channel is fixed and known in advance—the potential data. The utilization of the input channel is thus the incoming data divided by the potential data.

The capacity of the outward channel 26 is also known in advance, and we may refer to it as the output capacity or Max Forward. Assuming that the output channel is used to its maximum capacity as long as there is data to send, the data in the buffer will be the incoming data minus the output capacity plus data already in the buffer—existing data. The existing data minus the output capacity is a measure of the latency.

The embodiments use the above constructs to determine when to drop packets. A desired latency and a desired utilization may be specified in advance and a drop gate may be defined as a constant times a latency, or as a proportion of the desired latency times the utilization, or as a proportion of the desired utilization. For any time interval where that drop gate is greater than one, a packet or packets may be dropped.

The method of management of packet data traffic at a node on a network thus involves obtaining a current incoming data rate, the incoming data and comparing it with the overall channel capacity, the potential data, to obtain a current value for the utilization.

The current value of the latency may be obtained by comparing the existing data with an overall output channel capacity. As explained above the existing data is a function of the incoming data, the output capacity and the data already held in the buffer.

The above-described drop gate is obtained from the ratio that results from comparing the current utilization with a desired utilization, and the current latency with a desired latency, and when the ratio is above a threshold, typically unity then the node may start dropping incoming packets.

The present embodiments are herein referred to as the target utilization-latency integration protocol (TULIP) since utilization and latency are compared with target utilizations and latencies to arrive at packet dropping decisions.

In the following, we describe the calculations executed in each time frame for deciding if entering a drop phase. Secondly, we describe our packet drop strategy for the drop phase. Lastly, we analyze the methods of the present embodiments in terms of performance and memory requirements as well as showing that it does not require any configurations.

It is noted that the calculations may require all variables to be in the same or mutually compatible units, thus for example the data rate may be measured in bits per five milliseconds.

The present embodiments generally require only one measurement and knowledge of two fixed properties of the incoming and outgoing channels. At each time frame t, we require Ft as the total incoming data at time t. This is measured as the sum of incoming packet sizes across all incoming channels. We assume that we know Cᵢₙ which is the sum of determined capacities across all incoming channels. We also assume the knowledge of Cₒᵤₜ which is the determined capacity of the outgoing channel. Here we state that we have a buffer for each outgoing channel in the router. This is indeed the case in traffic management as packets do not wait for channels they are not going to use for forwarding.

### Stream Latency Evaluation

At the evaluation stage we calculate the utilization and the latency of the buffer. The benefit here is that the size of the buffer is also estimated and does not directly affect the evaluation. The reason this is an advantage is that the current buffer size disregards the rate of incoming data. Our calculation aggregates the current rate with previous rates of incoming data and, therefore, takes into account also the “near future”. This considers the case in which the rate slows down drastically while the buffer already contains enough packets to cause high latency for some time to come. In such a case, there is no reason to drop packets as the rate of incoming packets is low anyway and the existing packets in the buffer are not affected by packet drops.

Let Ft be the amount of incoming data at time t. Let Cin be the total possible rate of incoming data. Let Cₒᵤₜ be the total possible rate of outgoing data. We calculate

$${U}_{t} \text{?} = \frac{{F}_{t}}{{C}_{in} \cdot I}$$

$$\text{?} \text{indicates text missing or illegible when filed}$$

as the utilization at time t, where I is the configured interval time between evaluations. We denote Sₜ as the Load at time t. We set St=max(0, Sₜ₋₁+Fₜ−(Cₒᵤₜ·I)). We initiate S₀=0. Finally, we calculate the latency as

$$Lt = \frac{\text{?} {S}_{t}}{{C}_{out}} .$$

$$\text{?} \text{indicates text missing or illegible when filed}$$

We note here that Cᵢₙ, Cₒᵤₜ must be measured using the same rate unit and that Ft must be aggregated as units of data over an interval of the same length as their rate. (e.g. if I is in milliseconds and Fₜ is counted in bits, then Cᵢₙ, Cₒᵤₜ may be defined in terms of bpms, that is, bits per millisecond). Let l be the target latency and μ the target utilization. Let k>0 be an input parameter. We calculate

$$P = k \cdot \frac{{L}_{t}}{ℓ} \cdot \frac{{U}_{t}}{μ \text{?}} .$$

$$\text{?} \text{indicates text missing or illegible when filed}$$

For P≤1 we do not drop any packets. Otherwise, we enter the drop phase as discussed below.

Since the performance of AQMs is critical in both hardware and software, we wish to be as efficient as possible with the calculations performed. Note that Sₜ requires only additions and therefore is already efficient. Thus, according to necessity, we might wish to perform the calculation of P while using less multiplications and divisions. Then:

$$\begin{matrix}P = k \cdot \frac{{L}_{t}}{ℓ} \cdot \frac{{U}_{t}}{μ} \\ = k \cdot \frac{{S}_{t}}{ℓ \cdot {C}_{out}} \cdot \frac{{F}_{t}}{μ \cdot {C}_{in}} \\ = {S}_{t} {F}_{t} \cdot \frac{k}{ℓμ \cdot {C}_{out} \cdot {C}_{in}}\end{matrix} \qquad ( 1 )$$

Note that the expression

$$\frac{k}{ℓμ \cdot {C}_{out} \cdot {C}_{in}}$$

is made up of parameters which are not dependant on t. A single calculation of this expression, denoted δ, may be performed once and re-used as an input to the algorithm on each iteration. Thus, the calculation of P=δ·SₜFₜ requires no divisions and only two multiplications.

### Expected Trend Evaluation (ET)

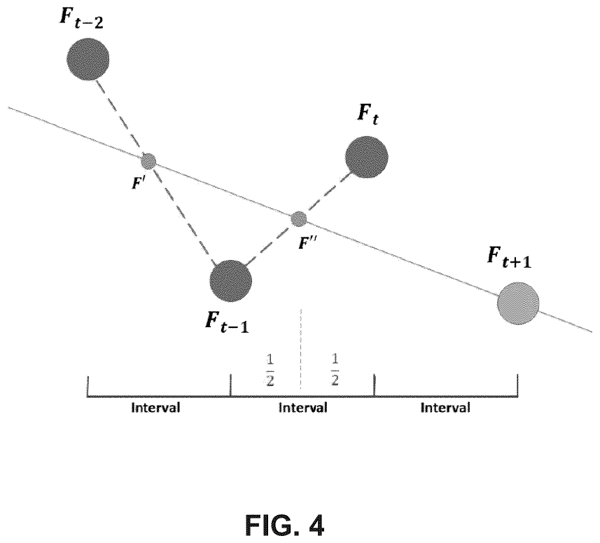

Referring now to FIG. 4, an extension of the evaluation of P as presented above is discussed. Ft−2, Ft−1 and Ft are three measurements of the incoming data in three successive time intervals. Averages F′ and F″ are calculated between successive measures and a guess for the next measurement Ft+1 is simply a continuation of the line 30 connecting F′ and F″. More particularly, the extension attempts to guess the trend of the rate of incoming data. It guesses a single data rate forward in time, i.e. Fₜ₊₁, and evaluates P using this guess.

We evaluate the Trend of the data rate in time t+1 as the line going through the middle values between sequential measurements. That is, let

$$\begin{matrix}{f}^{′} = \frac{{F}_{t - 2} + \text{?} {F}_{{t}_{1}}}{2} and \\ {f}^{″} = \frac{{F}_{t - 1} + {F}_{t}}{2}\end{matrix}$$

$$\text{?} \text{indicates text missing or illegible when filed}$$

be the averages of the last two sequential pairs. Then the straight line between f′ and f″ represents the line for which the sum of the distances to Fₜ₋₂, Fₜ₋₁, Fₜ is the smallest. The trend we guess is the slope of the line. Note here that the distance between f′ and f″ in time is exactly a single interval (the same as between Fₜ₋₂ and Fₜ₋₁). That is, the slope is

$$α = \frac{{f}^{″} - {f}^{′}}{1} = \frac{{F}_{t} - {F}_{t - 2}}{2} .$$

Now, the distance between the end of this line (the point f″) and the value we wish to expect, which is Fₜ₊₁, is 3/2 of the normal interval.

Therefore,

$$\begin{matrix}{F}_{t + 1} = {f}^{″} + \frac{3 α}{2} \\ = \frac{{F}_{t - 1} + {F}_{t}}{2} + \frac{3 ( {F}_{t} - {F}_{t - 2} )}{4} \\ = \frac{5 {F}_{t} + 2 {F}_{t - 1} - 3 {F}_{t - 2}}{4}\end{matrix} \qquad ( 2 )$$

Using the above guess we evaluate Sₜ₊₁=max(0, Sₜ+Fₜ₊₁−Cₒᵤₜ). We also guess the

$${U}_{t + 1} = \frac{{F}_{t + 1}}{{C}_{i} n}$$

expected utilization and the expected latency

$${L}_{t + 1} = \frac{{S}_{t + 1}}{{C}_{o} ut} .$$

Now the evaluation of P is made using the expected values where P=

$$k \text{?} \cdot \frac{{L}_{t + 1}}{ℓ} \cdot \frac{{U}_{t + 1}}{μ} .$$

$$\text{?} \text{indicates text missing or illegible when filed}$$

We show here as well that this method is not performance heavy. Note that calculating Fₜ₊₁ contains a single division by 4, which is a simple two bits shift right operation. The same arithmetic provided at Equation 1 applies here, and so

$$P = {S}_{t + 1} {F}_{t + 1} \cdot \frac{k}{ℓμ \cdot C {\text{?}}_{out} \cdot {C}_{in}} .$$

$$\text{?} \text{indicates text missing or illegible when filed}$$

Therefore, having the same constant as in Equation 1, we require no divisions for applying this method for the present protocol.

### The Drop Phase

In this section we describe the drop strategy of our protocol. For a determined P at time t, we enter a drop phase if P>1. First, we assume that we know the source port (or channel) for each packet received in the router (before enqueuing). At this stage, we consider a single buffer, one in which all packets have the same priority of service. This is since our calculated P serves to evaluate a single buffer for a specific service. Therefore, let T₁, . . . , Tₙ be the input channels directed to this buffer. Our protocol uses a round-robin technique to drop a single packet per Tᵢ. We offer two different approaches for the number of packets we drop before the next evaluation of P.

### Single Drop (SD)

We drop a single packet between evaluations according to the round robin scheme. Once a drop has occurred, we execute the algorithm again in a shorter interval than before. Let I be the original interval in which the algorithm is executed. Let P′ be the last value received from the evaluation and P be the value received from the current evaluation. If P>1, we execute the next evaluation algorithm at interval I/P·2^{ω} where ω is calculated as:

$$w = \{ \begin{matrix}w + 1 , & {P}^{′} <= P \\ max ( 1 , w - 1 ) , & otherwise\end{matrix}$$

If P<=1, we execute the next evaluation after the original interval I. Also, to prepare for future possible phase drops, we reset the interval variable to I/P and set P′=0.

### Target Ratio Drop (TRD)

Let R₁, . . . , Rₙ be the sizes of input on each of the n channels entering the buffer. We denote

$$D = \text{?} {F}_{t} - \frac{{F}_{t}}{P} .$$

$$\text{?} \text{indicates text missing or illegible when filed}$$

We assume that a drop on a channel i will, at worst, drop Rᵢ by half. And so, we drop x packets at once, using the round robin scheme, starting with the current index of the round robin j such that x is the smallest integer such that

$$\sum \frac{{R}_{i}}{2} \geq D .$$

That is, we guess that dropping x packets, one from each of the channels j, . . . , j+x will reduce the rate of incoming data by D, which is the amount of data causing the latency-utilization ratio to be larger than 1. Note that for finding x we simply iteratively reduce integers that are divided by 2. Each such division is a single right-bit-shift on an integer and as such optimized for performance. Thus, we use a single division for this stage of the algorithm.

### Pseudo-Code

The following algorithm describes the evaluation phase.

TABLE 1
Pseudocode for the evaluation stage
Algorithm 1 EVALUATE

Require: TargetLatency > 0 [symbol] in milliseconds
Require: 1 >= TargetUtil > 0
Require: TargetLatency >= I > 0 [symbol] interval length in milliseconds
Require: K > 0
Require: Cᵢₙ > 0 [symbol] Sum of Capacity of incoming ports in bits-per-millisecond
Require: Cₒᵤₜ > 0 [symbol] Sum of Capacity of outgoing ports in bits-per-millisecond
Require: PrevSize [symbol] Previous value of buffer size, initialized as 0 and
maintained in the algorithm

| | |
|---|---|
| 1: | For I milliseconds, count the number of bits entering all ports, denote as F. |
| 2: | $U = \frac{F}{{C}_{i n} \cdot t}$ |
| 3: | S = max(0, PrevSize + F − (I · Cₒᵤₜ) |
| 4: | $L = \frac{S}{{C}_{out}}$ |
| 5: | PrevSize = S |
| 6: | if L < TargetLatency then |
| 7: | P =0 |
| 8: | else |
| 9: | $P = K \cdot \frac{L}{TargetLatency} \cdot \frac{U}{TargetUtil}$ |
| 10: | end if |
| 11: | Return P |

The next two algorithms describe the two different strategies of the drop phase. Note that in case we use procedure SingleDrop (Algorithm 2), we execute the procedure Evaluate (Algorithm 1) in changing intervals as set by the SingleDrop procedure given in table 2.

TABLE 2
SingleDrop part
Algorithm 2 SingleDrop

```
Require: DropPortIndex [symbol]  The index of the port from which we are about
  to drop, initialized as 0 and maintained during the algorithm
Require: tick [symbol]   The current interval time, initialized to $\frac{I}{P}$
  and maintained during the algorithm
Require: PrevP [symbol]  The last evaluation value, initialized to 0,
  maintained during the algorithm
```

| | |
|---|---|
| 1: | Drop a packet at port with index DropPortIndex. |
| 2: | Increment DropPortIndex by 1 modulo number of ports. |
| 3: | if P >= PrevP then |
| 4: | $tick = \frac{tick}{2}$ |
| 5: | else |
| 6: | $tick = min ( 2 \cdot tick , \frac{I}{2 P} )$ |
| 7: | end if |
| 8: | PrevP = P |

TABLE 3
Target Ratio Drop part
Algorithm 3 TargetRatioDrop

```
Require: DropPortIndex [symbol]  The index of the port from which we are about
  to drop, initialized as 0 and maintained during the algorithm
Require: F[1], . . . , F[n] [symbol]   Each F[i] is the incoming capacity in bits of
  port with index i for interval I
```

| | |
|---|---|
| 1: | $D = F - \frac{F}{P}$ |
| 2: | while D > 0 do |
| 3: | Drop a packet at port with index DropPort Index. |
| 4: | D = D − F[DropPort Index]/2 |
| 5: | Increment DropPortIndex by 1 modulo number of ports. |
| 6: | end while |

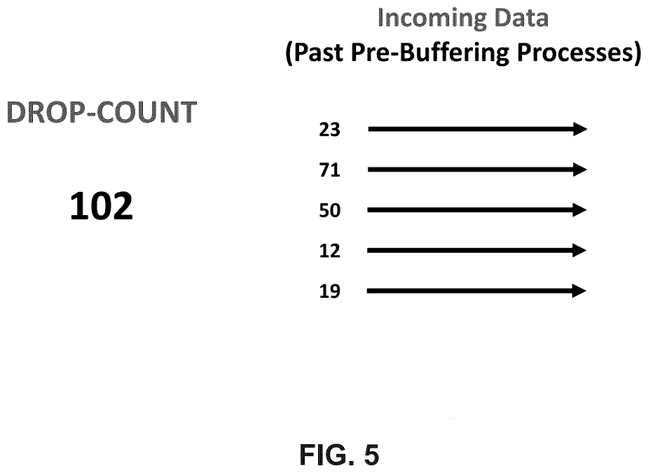

FIGS. 5 to 12 illustrate a worked example of the use of the target ratio drop. There are five channels, with incoming data. Respective channels have 23, 71, 50, 12 and 19 packets each.

The drop count comes to 102.

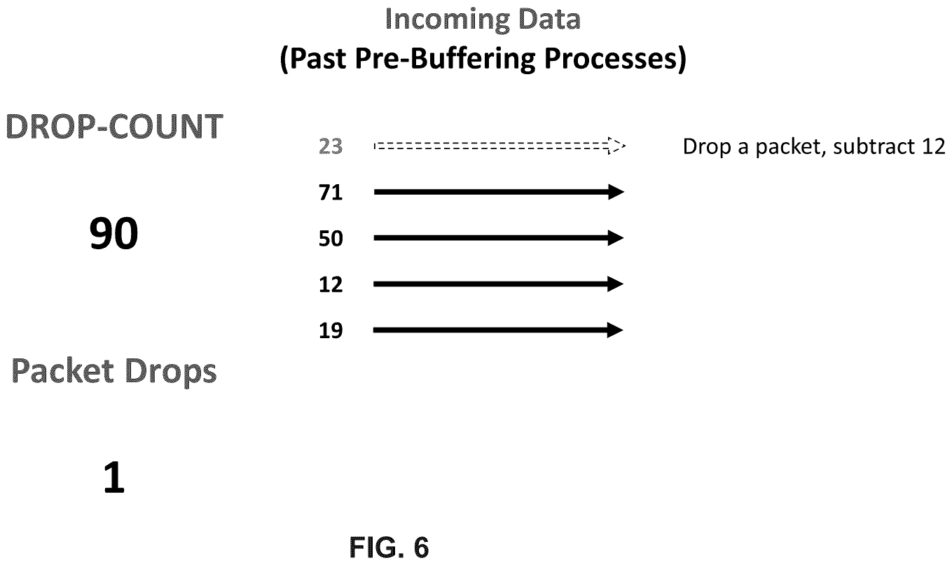

In FIG. 6 a packet is dropped from the first channel, and 12-obtained by dividing the channel size in two and discarding the remainder, a simple right shift in binary, is subtracted from the original drop count as per line 4 in table 3.

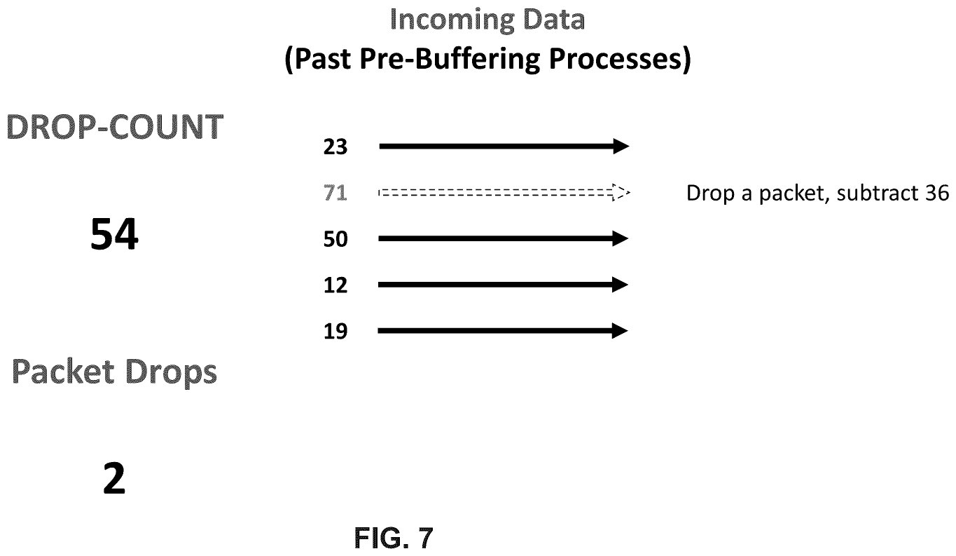

In FIG. 7, a packet is dropped from the second channel, and this time 36 is subtracted from the drop count, being half of 71 discarding the remainder.

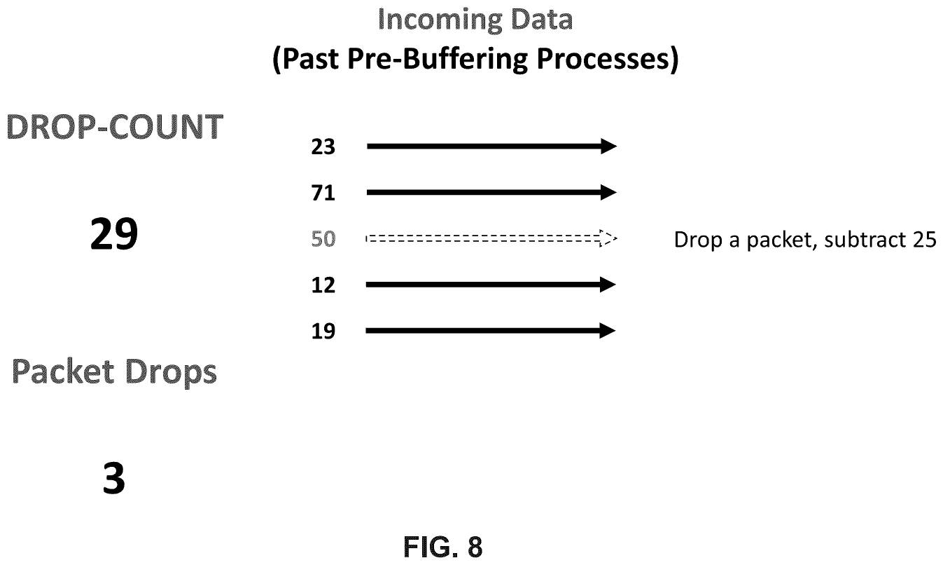

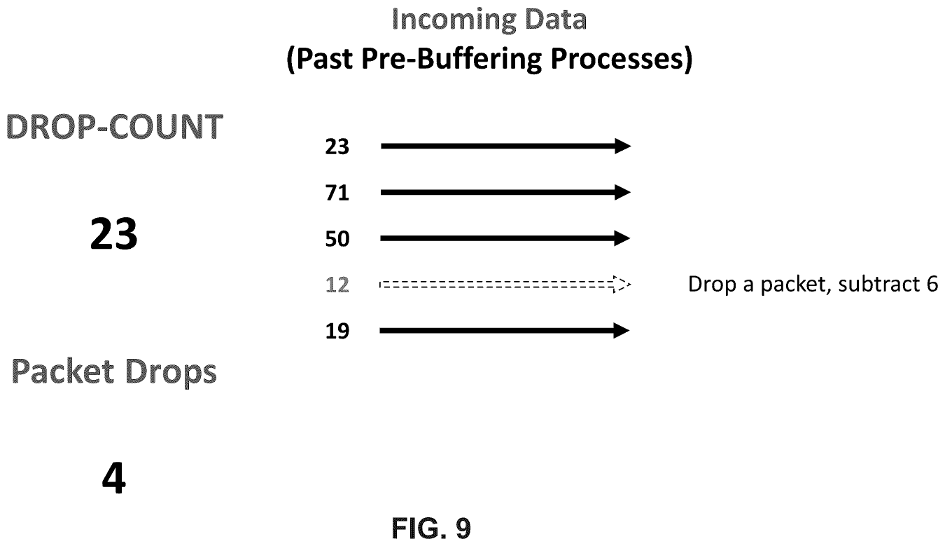

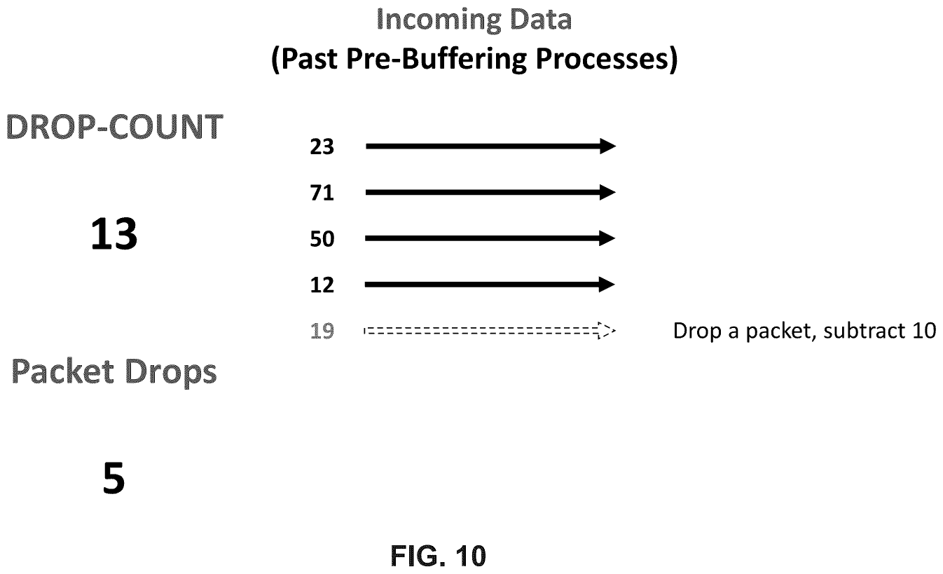

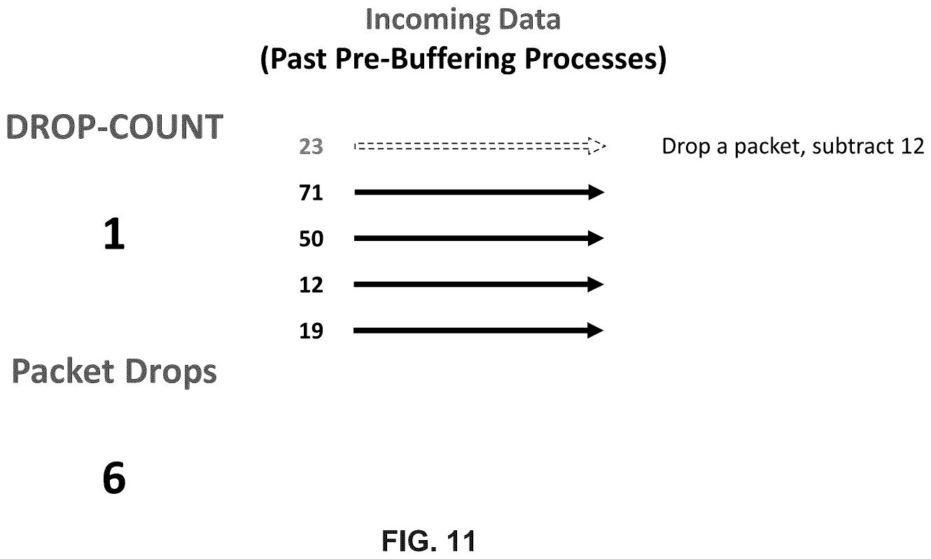

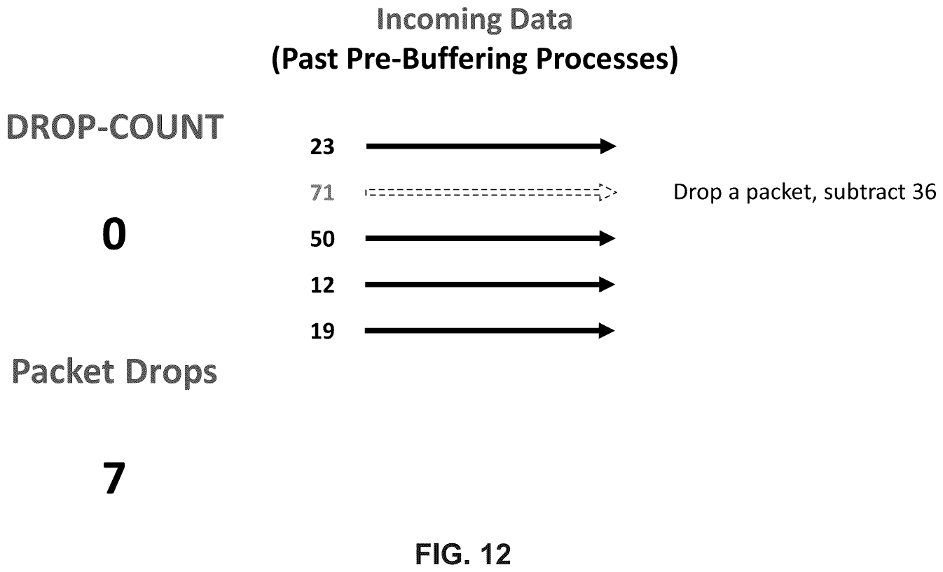

In FIG. 8, the same is done for the third channel, and the drop count reaches 29. In FIG. 9, the drop count reaches 23 as a packet is dropped from the fourth channel. In FIG. 10 the same is done for the fifth channel. In FIG. 11 the process returns to the first channel and 22 is subtracted from the drop count to leave one. As the drop count is still positive the process is repeated once again for the second channel in FIG. 12, and the drop count reaches zero ending the process. The management system then re-evaluates the drop count for the next interval.

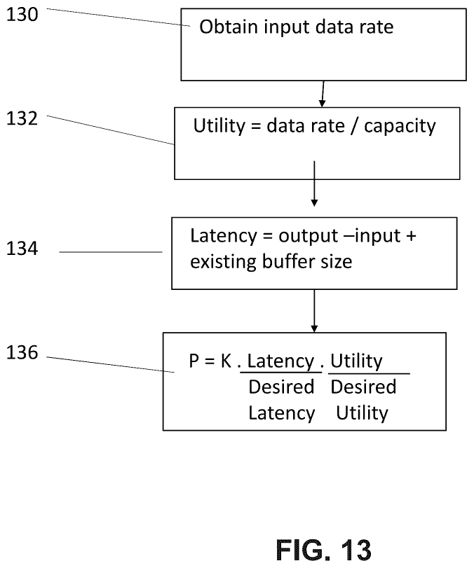

FIG. 13 is a simplified flow chart illustrating the procedure for evaluating P, and the drop count. In stage 130 the input data rate is measured for any given time period. In 132, the utility is calculated as the ratio of the measured data rate to the capacity. In 134, the latency is calculated as the data out minus the data in plus the existing buffer size. Then in 136, P is calculated.

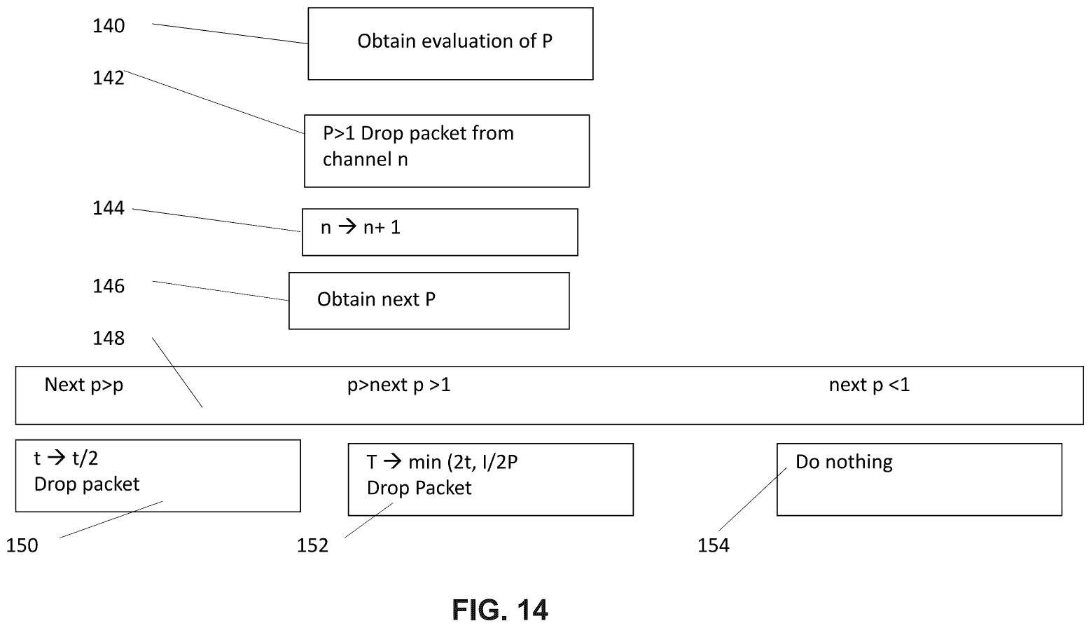

FIG. 14 is a simplified flow chart illustrating the single drop method according to embodiments of the present invention. An evaluation of P is obtained—140, as per FIG. 13 above. If P is greater than unity 142 then a packet is dropped from the nth channel. The channel number is incremented 144 and the next P is obtained 146 and compared 148 with the previous P. If P is growing then the time interval is halved and a packet is dropped, 150. If P is greater than unity but not growing then a packet is dropped but the time interval is either doubled or kept to ½P—152 or if P has fallen to below unity then nothing is done 154.

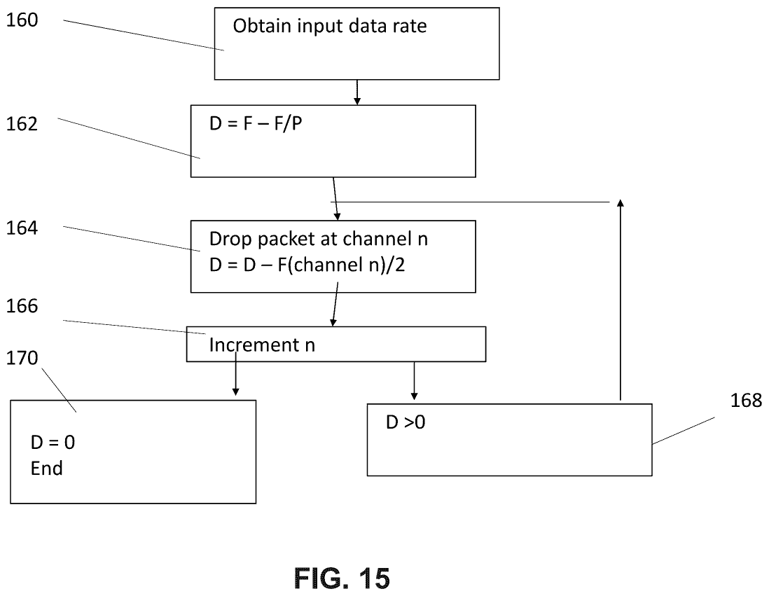

FIG. 15 illustrates the target ratio drop method according to embodiments of the present invention. As before, the data rate is obtained, 160. The drop number D is obtained as F-F/P—162. As long as D is greater than 0, a packet is dropped at the current channel and D is reduced by half the size of the current channel—164. The channel number is incremented 166 and the process repeats 168 until D is reduced to 0 at 170.

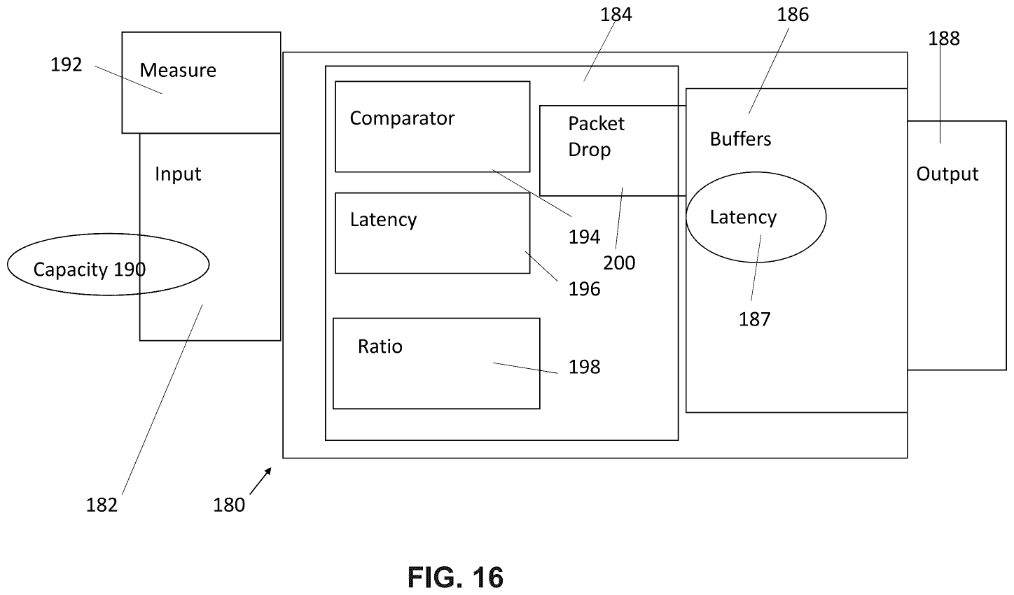

Reference is now made to FIG. 16, which illustrates a node 180 according to embodiments of the present invention. Node 180 has input channel(s) 182 for receiving packet data for onward transfer over a network, and a packet management unit 184, one or more buffers 186, a latency 187 depending on buffer usage, one or more output channels 188 and an overall channel capacity 190. The management unit includes a measurement unit 192 which measures the current incoming data and obtains a rate per time interval.

A comparator 194 is connected with the measurement unit and compares the current incoming data rate with the overall channel capacity 190 to obtain a current utilization.

A latency unit 196 obtains a current latency by comparing the incoming data rate with an overall output channel capacity as well as the amount of data already in the buffer.

A ratio unit 198 is connected to the latency unit 196 and the comparator 194 and obtains a ratio by comparing the current utilization with a desired utilization, and the current latency with a desired latency as described above.

Packet dropping unit 200 is connected to the ratio unit 198 and drops incoming packets if the ratio is above a threshold. The Packet dropping unit may adopt the single drop method or the target ratio drop method as desired.

Accordingly the present embodiments may manage packet data at a node on a network on the basis of measured utilization and latency, and may drop packets evenly between the various data flows and channels.

### General

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of management of packet data traffic at a node on a network, the node having at least one input channel, at least one buffer, a latency depending on buffer usage, at least one output channel and an overall channel capacity, the method comprising:
obtaining a current incoming data rate and comparing it with the overall channel capacity to obtain a current utilization;
obtaining a current latency by comparing said incoming data rate with an overall output channel capacity;
obtaining a ratio by comparing said current utilization with a desired utilization, and said current latency with a desired latency; and
if the ratio is above a threshold then dropping incoming packets.

2. The method of claim 1, wherein said at least one incoming channel comprises a plurality of incoming channels, the method comprising evenly selecting packets for said dropping from different ones of said plurality of incoming channels.

3. The method of claim 1, wherein said obtaining a current incoming data rate and obtaining said ratio is carried out for successive time intervals.

4. The method of claim 1, wherein said threshold is unity.

5. The method of claim 1, wherein said overall channel capacity is an overall input channel capacity and said current utilization is calculated from said input channel capacity.

6. The method of claim 1, wherein said current latency further comprises an estimate of data packets waiting in said buffer, said estimate being obtained from differences between respective input data rates of said earlier time periods compared with said output channel capacity.

7. The method of claim 2, wherein if said ratio is above said threshold, a single packet is dropped and then said ratio is re-evaluated, and following said re-evaluation:
if said ratio is found to have increased then the time interval is halved and a further packet is dropped;
if said ratio is found not to have increased but is still above said threshold then said time interval is set to the minimum of double a current time interval and half an original time interval and a further packet is dropped; and
if said ratio is no longer above said threshold no packet is dropped.

8. The method of claim 7, wherein successive ones of said packets being dropped are dropped from different ones of said input channels.

9. The method of claim 2, wherein if said ratio is above said threshold:
a number of packets to be dropped is obtained by comparing said ratio to the current incoming data rate;
one packet is dropped from a first of said plurality of input channels and said number of packets to be dropped is decremented;
further packets are dropped from successive ones of said plurality of input channels with corresponding decrementing of said number of packets to be dropped, until said number of packets to be dropped reaches zero.

10. The method of claim 9, wherein said number of packets to be dropped is an estimate of how many packets need to be dropped from said current incoming data rate to reduce said ratio to unity.

11. The method of claim 1, comprising dropping said incoming packets prior to entering said buffer.

12. The method of claim 1, comprising modifying said ratio based on a trend obtained from successive measurements of said incoming data rate over successive time intervals.

13. A node for transfer of packet data over a network, the node having a packet management unit, at least one input channel, at least one buffer, a latency depending on buffer usage, at least one output channel and an overall channel capacity, the node comprising:
a measurement unit configured to obtain a current incoming data rate;
a comparator connected with the measurement unit and configured to compare the current incoming data rate with the overall channel capacity to obtain a current utilization;
a latency unit configured to obtain a current latency by comparing said incoming data rate with an overall output channel capacity;
a ratio unit connected to said latency unit and said comparator, for obtaining a ratio by comparing said current utilization with a desired utilization, and said current latency with a desired latency; and
a packet dropping unit connected to the ratio unit to drop incoming packets if the ratio is above a threshold.

14. The node of claim 13, wherein said at least one incoming channel comprises a plurality of incoming channels, the packet dropping unit configured to evenly select packets for said dropping from different ones of said plurality of incoming channels.

15. The node of claim 13, wherein said obtaining a current incoming data rate and obtaining said ratio is carried out for successive time intervals.

16. The node of claim 13 wherein said threshold is unity.

17. The node of claim 13, wherein said overall channel capacity is an overall input channel capacity and said current utilization is calculated from said input channel capacity.

18. The node of claim 13, wherein said current latency further comprises an estimate of data packets waiting in said buffer, said estimate being obtained from differences between respective input data rates of said earlier time periods compared with said output channel capacity.

19. The node of claim 14, wherein said packet dropping unit is configured so that if said ratio is above said threshold, a single packet is dropped and then said ratio is re-evaluated, and following said re-evaluation:
if said ratio is found to have increased then the time interval is halved and a further packet is dropped;
if said ratio is found not to have increased but is still above said threshold then said time interval is set to the minimum of double a current time interval and half an original time interval and a further packet is dropped; and
if said ratio is no longer above said threshold no packet is dropped.

20. The node of claim 14, wherein said packet dropping unit is configured so that if said ratio is above said threshold:
a number of packets to be dropped is obtained by comparing said ratio to the current incoming data rate;
one packet is dropped from a first of said plurality of input channels and said number of packets to be dropped is decremented;
further packets are dropped from successive ones of said plurality of input channels with corresponding decrementing of said number of packets to be dropped, until said number of packets to be dropped reaches zero.

21. The node of claim 20, wherein said number of packets to be dropped is an estimate of how many packets need to be dropped from said current incoming data rate to reduce said ratio to unity.

22. The node of claim 13, wherein said packet dropping unit is configured to drop respective incoming packets prior to entering said buffer.

23. The node of claim 13, wherein said ratio unit is configured to modify said ratio based on a trend obtained from successive measurements of said incoming data rate over successive time intervals.
